(19) United States
(12) Patent Application Publication
(10) Pub. No.: US 2017/0180623 A1
(43) Pub. Date: Jun. 22, 2017

(54) SELFIE-DRONE SYSTEM AND PERFORMING METHOD THEREOF

(71) Applicant: National Taiwan University of Science and Technology, Taipei (TW)

(72) Inventor: Chyi-Yeu LIN, Taipei (TW)

(21) Appl. No.: 15/371,260

(22) Filed: Dec. 7, 2016

(30) Foreign Application Priority Data
Dec. 18, 2015 (TW) 104142830

(51) Int. Cl. H04N 5/232; G05D 1/00; G11B 27/031

(52) U.S. Cl. CPC H04N 5/23203; G11B 27/031; H04N 5/23222; G05D 1/0094

(57) ABSTRACT

A selfie-drone system and a performing method thereof are disclosed. The selfie-drone system includes a selfie-drone body; a camera unit; a selecting unit electrically coupled to a database, the database including a plurality of selfie photo templates, the selecting unit utilized for selecting at least one of the selfie photo templates from the database, each of the selfie photo templates includes at least one selfie parameter; and a controlling unit utilized for receiving the at least one selfie parameter of the at least one of the selfie photo templates selected by the selecting unit, controlling the selfie-drone body to fly to a specific height and a specific angle matching to the at least one selfie parameter, and controlling the camera unit to photograph. A selfie person can view effect of a selfie photo in advance via the selfie-drone system.

### RELATED APPLICATION

This application claims the benefit of priority Taiwan Patent Application No. 104142830 filed Dec. 18, 2015, the contents of which are incorporated herein by reference in their entirety.

### FIELD AND BACKGROUND OF THE INVENTION

The present invention relates to a selfie field, and more particularly to a selfie-drone system and a performing method thereof.

Currently, more and more people utilize drones (dynamic remotely operated navigation equipment) to take photos. When a person taking a selfie (hereinafter referred to as “selfie person”) utilizes a drone to perform a selfie, the selfie person controls the drone to take a photo toward the selfie person at a proper height.

Important factors of a selfie photo with satisfactory effect include a position, a distance, and an angle of the selfie person, which appears in the selfie photo. When the selfie person hopes to appear at a right position in the selfie photo, it is required to control a camera disposed in the drone to be moved toward the left of the selfie person. When the selfie person hopes that the selfie person occupies a smaller area in the selfie photo (i.e. the scenery occupies a larger area), it is required to control the camera to be back away or far away from the selfie person. When the selfie person hopes that the selfie person's face orientation is toward the left in the selfie photo, it is required to control the camera to be moved toward the left of the selfie person's face.

In one method for controlling a drone to take a photo, the selfie person can input a height, a position, and an orientation of the drone in a digital format. Then, the drone can fly to the requested height, position, and orientation. However, because the selfie person cannot view the effect of the selfie photo in advance, the selfie photo taken by the drone at the requested height, position and orientation set can only satisfy the selfie person by chance. Specifically, the selfie person cannot precisely control a position and a size of an image of the selfie person in the selfie photo by simply defining the height, position, and orientation of the drone to take the photo. As a result, the taken selfie photo cannot necessarily achieve the selfie person's expected effect.

In another method for controlling a drone to take a photo, the selfie person manually utilizes a drone controller or a cell phone APP to control the flight of the drone and adjusts the flight of the drone according to the images transmitted from the drone or the position of the selfie person in the images. The manual control commands usually include six flight modes: Up, Down, Forward, Backward, Left and Right. After the selfie person is satisfied with the images transmitted from the drone, the selfie person controls the drone to take the photo. In the method, the selfie person needs to spend a large amount of time on iteratively viewing the images and then control the flight of the drone in a non-intuitive method. The method is inconvenient and inefficiency. It is noted that controlling the flight of the drone to adjust the image of the selfie person to show at an ideal position, an ideal size, and an ideal orientation (angle) in the photo is difficult, non-intuitive, and time consuming.

For the drone to record selfie movies in an automated manner, many drone companies offer options such as Follow me, Lead, Circle, Loop, and Side. These options will be executed by embedded control programs which will always create the identical recorded video effects with same relative distance, height and angle between the drone and the person to be recorded. The drone user cannot ask the drone to make the video recording in a specific way to his preference. Therefore, the current drones fail to make video recording according to user defined distance, angle, height, and time duration at each view position.

Consequently, there is a need to solve the above-mentioned problems when the drones are utilized to take photos in the prior art.

### SUMMARY OF THE INVENTION

An objective of the present invention is to provide a selfie-drone system and a performing method thereof which can solve the problems when drones are utilized to take photos in the prior art.

A selfie-drone system in accordance with the present invention comprises a selfie-drone body; a camera unit disposed in the selfie-drone body; a selecting unit electrically coupled to a database, the database including a plurality of selfie photo templates, the selecting unit utilized for selecting at least one of the selfie photo templates from the database, each of the selfie photo templates including at least one selfie parameter, and the at least one selfie parameter comprising a position and a size of at least one pattern in the corresponding selfie photo template; and a controlling unit electrically coupled to the camera unit and the selecting unit and utilized for receiving the at least one selfie parameter of the at least one of the selfie photo templates selected by the selecting unit, controlling the selfie-drone body based on the at least one selfie parameter to fly to a specific height and a specific angle matching to the at least one selfie parameter, and controlling the camera unit to take a photo or shoot a film.

In the performing method of the selfie-drone system in accordance with the present invention, the selfie-drone system comprises a selfie-drone body, a camera unit, a selecting unit, and a controlling unit. The performing method of the selfie-drone system comprises: selecting at least one of a plurality of selfie photo templates from a database by the selecting unit, each of the selfie photo templates including at least one selfie parameter, and the at least one selfie parameter comprising a position and a size of at least one pattern in the corresponding selfie photo template; receiving the at least one selfie parameter of the at least one of the selfie photo templates by the controlling unit; and controlling the selfie-drone body based on the at least one selfie parameter to fly to a specific height and a specific angle matching to the at least one selfie parameter by the controlling unit, and controlling the camera unit to take a photo or shoot a film.

The selfie person can view the effect of a selfie photo in advance via the selfie-drone system and the performing method thereof in accordance with the present invention.

### BRIEF DESCRIPTION OT THE SEVERAL VIEWS OF THE DRAWINGS

FIG. 1 shows a block diagram of a selfie-drone system in accordance with an embodiment of the present invention.

FIG. 2 shows a flowchart of a performing method of a selfie-drone system in accordance with an embodiment of the present invention.

### DESCRIPTION OF SPECIFIC EMBODIMENTS OF THE INVENTION

To make the objectives, technical schemes, and technical effects of the present invention more clear and definite, the present invention will be described in detail below by using embodiments in conjunction with the appending drawings. It should be understood that the specific embodiments described herein are merely for explaining the present invention, and as used herein, the term “embodiment” refers to an instance, an example, or an illustration but is not intended to limit the present invention.

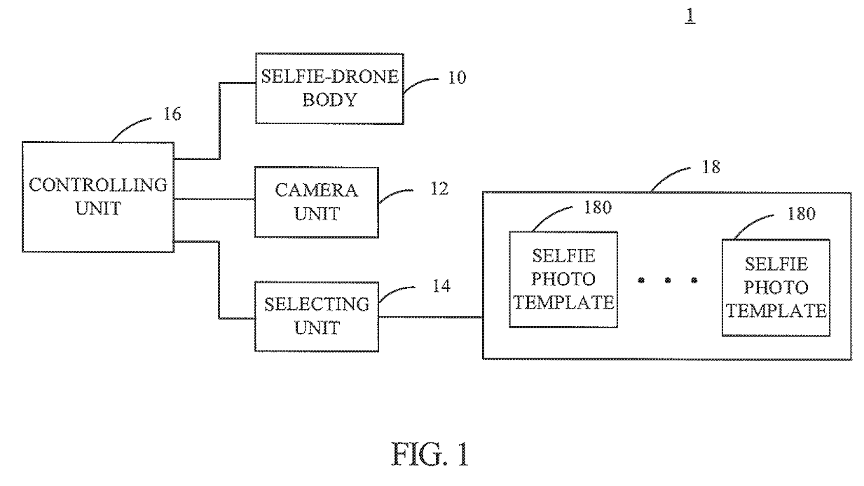

Please refer to FIG. 1. FIG. 1 shows a block diagram of a selfie-drone system 1 in accordance with an embodiment of the present invention.

The selfie-drone system 1 comprises a selfie-drone body 10, a camera unit 12, a selecting unit 14, and a controlling unit 16.

The camera unit 12 is disposed in the selfie-drone body 10 and utilized for taking a picture or shooting a film with respect to a selfie person.

The selecting unit 14 is electrically coupled to a database 18. The database 18 includes a plurality of selfie photo templates 180. The selecting unit 14 is utilized for selecting at least one of the selfie photo templates 180 from the database 18. Each of the selfie photo templates 180 includes at least one selfie parameter.

The controlling unit 16 is electrically coupled to the camera unit and the selecting unit and utilized for receiving the at least one selfie parameter of the at least one of the selfie photo templates 180 selected by the selecting unit 14, controlling the selfie-drone body 10 to fly to a specific height and a specific angle matching to the at least one selfie parameter, and controlling the camera unit 12 to take a photo or shoot a film.

In the present invention, the selfie photo templates 180 can be categorized into different classifications. In one embodiment, one of the selfie photo templates 180 can be a one-person template. The one-person template means that a template comprises a pattern. The pattern can be a portrait pattern, a vehicle pattern, and so on. When the selfie person selects the one-person template, the controlling unit 16 receives the at least one selfie parameter of the one-person selfie photo templates, controls the drone body 10 to fly to a specific height and a specific angle matching to the at least one selfie parameter, and controls the camera unit 12 to take a photo or shoot a film. The position and the size of the selfie person in the taken photo are the same as those of the pattern in the one-person template. That is, in the present embodiment, the selfie parameter of each of the selfie photo templates 180 comprises the position and the size of the pattern in the corresponding selfie photo template 180.

In another embodiment, the selfie parameter of each of the selfie photo templates 180 comprises an orientation angle of a portrait pattern (for example, a face orientation angle) in the corresponding selfie photo template. In yet another embodiment, the selfie parameter of each of the selfie photo templates 180 comprises at least one of the positions, the sizes, and the orientation angles of a plurality of patterns (for example, a multi-person template comprising a plurality of patterns) in the corresponding template.

In the selfie-drone system in accordance with the present invention, the visual servoing techniques are applied to control the selfie-drone body 10 to fly to a specific height and a specific angle matching to the selfie-drone body 10. Specifically, the selfie-drone system in accordance with the present invention adopts the imaged-based visual servoing (IBVS) techniques. That is, a specific position of a characteristic mark of an object with a specific size in a photo is selected in advance (i.e. a selfie photo template is selected). The controlling unit 16 continuously adjusts the position and the attitude of the selfie-drone body 10 according to the size and the position of the characteristic mark of the selected object appearing in a screen of the camera unit 12. The position and the attitude of the selfie-drone body 10 are adjusted, so that the image of the selfie person is positioned in the specific position in the photo. As mentioned above, the characteristic mark of an object can be a position, a size, or an orientation angle of the object. For example, the visual servoing techniques can detect the position, the size, or the face orientation angle.

In one embodiment, the selfie photo templates 180 in the database 18 can be stored in a mobile terminal, such as a mobile phone, a tablet, and so on. The selfie person can view and select the selfie photo templates 180 through a display panel of the mobile terminal.

In another embodiment, the selfie photo templates 180 in the database 18 can be stored in the controlling unit 16. The selfie person can view and select the selfie photo templates 180 through a display panel electrically coupled to the controlling unit 16. In one embodiment, the selfie photo templates can be stored in the database 18 in advance.

In another embodiment, when the selfie person is not satisfied with the selfie photo templates 180, the selfie person can upload a photo with satisfying selfie effect to the controlling unit 16. Then, the controlling unit 16 can convert the photo into a selfie photo template 180 to acquire at least one selfie parameter and store the selfie photo template 180 in the database 18. That is, the selfie person can create a selfie photo template 180 manually and store it in the database 18.

Furthermore, the selecting unit 14 can select plural selfie photo templates 180 from the database 18. The controlling unit 16 receives the selfie parameters of the selected selfie photo templates 180, controls the selfie-drone body 10 to fly to the specific heights and the specific angles matching to the selfie parameters according to the selection sequence of the selected selfie photo templates 180 and the selfie parameters, and controls the camera unit 12 to take photos or shoot a film.

In another embodiment, the controlling unit 16 sets sequence priorities of the selected selfie photo templates 180, controls the selfie-drone body 10 to fly to the specific heights and the specific angles matching to the selfie parameters according to the sequence priorities and the selfie parameters, and controls the camera unit 12 to take photos or shoot a film. The sequence priorities are set according to the shortest distance of the flight path. The shortest distance of the flight path is the shortest flight distance of the selfie-drone body 10 to travel one after one to all estimated photo taking positions of all selected selfie photo templates in a particular sequence.

Although the imaged-based visual servoing (IBVS) techniques perform automatic motion control on the selfie-drone body 10 according to a position and a size of an object in a photo (i.e. the selfie parameters), the relationships of different positions and sizes (i.e. the selfie parameters) of the object appearing in one selfie photo template 180 and relative positions of the camera unit 12 can be derived in advance. As a result, when plural selfie photo templates 180 are selected, required relative positions of the camera unit 12 can be calculated based on the selfie parameters of the selfie photo templates 180. Then, the shortest flight distance is set according to the required relative positions, so that the traveling distance which is required when the selfie-drone system 1 finishes taking photos according to all of the selected selfie photo templates 180 is the shortest.

Furthermore, the selfie person can select plural selfie photo templates 180 from the database 18 with the selecting unit 14 and can set a time duration of each of the selected selfie photo templates 180 with the selecting unit 14. The controlling unit 16 receives the selfie parameters of the selected selfie photo templates 180, controls the selfie-drone body 10 to fly to specific the heights and the specific angles matching to the selfie parameters of the selected selfie photo templates 180 according to the selfie parameters of the selected selfie photo templates 180 and the time duration of each of the selected selfie photo templates 180, and controls the camera unit 12 to shoot films. Finally, the controlling unit 16 combines the films corresponding to the selected selfie photo templates 180 into a new film.

Furthermore, when somebody or some people appear in the background of the selfie person, the selfie-drone system 1 might be disrupted and cannot recognize who the selfie person is. The selfie-drone system 1 can adopt the visual recognition techniques to determine who the selfie person is in a multi-person template. For example, the selfie person performs a specific action (e.g. a gesture) after the selfie person selects the multi-person template. By adopting the visual servoing techniques, the controlling unit 16 can recognize the action to determine the selfie person and control an image of the selfie person to be displayed in a specific position of a taken photo according to the selfie parameters of the multi-person template.

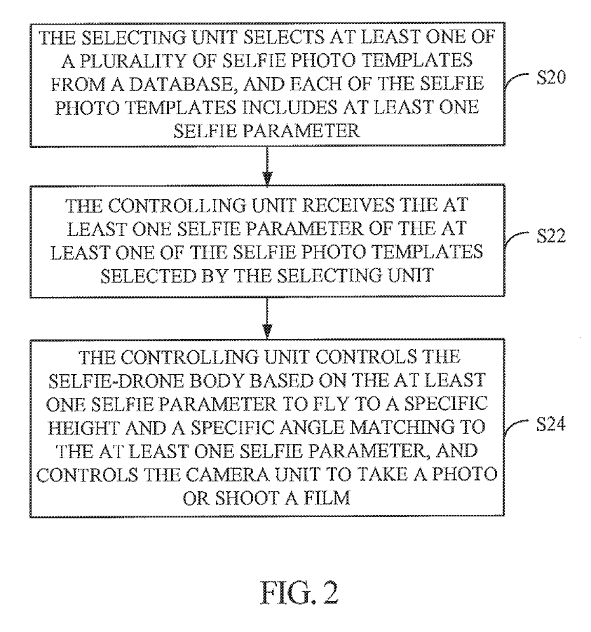

Please refer to FIG. 2. FIG. 2 shows a flowchart of a performing method of a selfie-drone system in accordance with an embodiment of the present invention.

The selfie-drone system comprises a selfie-drone body, a camera unit, a selecting unit, and a controlling unit. The performing method of the selfie-drone system comprises the following steps.

In step S20, the selecting unit selects at least one of a plurality of selfie photo templates from a database. Each of the selfie photo templates includes at least one selfie parameter.

In one embodiment, the selfie parameter of each of the selfie photo templates comprises a position and a size of at least one pattern in the corresponding selfie photo template. In another embodiment, the selfie parameter of each of the selfie photo templates comprises an orientation angle of a portrait pattern (for example, a face orientation angle) in the corresponding selfie photo template.

In yet another embodiment, at least one of the selfie photo templates is created by converting a photo which is uploaded to the selfie-drone system.

Furthermore, the selfie photo templates can be stored in a mobile terminal or the controlling unit.

In step S22, the controlling unit receives the at least one selfie parameter of the at least one of the selfie photo templates selected by the selecting unit.

In step S24, the controlling unit controls the selfie-drone body based on the at least one selfie parameter to fly to a specific height and a specific angle matching to the at least one selfie parameter, and controls the camera unit to take a photo or shoot a film.

In one embodiment, the selfie-drone system can adopt the visual recognition techniques to determine who the selfie person is in a multi-person template. For example, the selfie person performs a specific action (e.g. a gesture) after the selfie person selects the multi-person template. By adopting the visual servoing techniques, the controlling unit can recognize the action to determine the selfie person and control an image of the selfie person to be displayed in a specific position of a taken photo according to the selfie parameters of the multi-person template.

In one embodiment, the selecting unit selects plural selfie photo templates from the database in step S20. The controlling unit controls the selfie-drone body to fly to the specific heights and the specific angles matching to the selfie parameters according to the selection sequence of the selected selfie photo templates and the selfie parameters and controls the camera unit to take photos or shoot a film in step S24.

In another embodiment, the selecting unit selects plural selfie photo templates from the database in step S20. The controlling unit sets sequence priorities of the selected selfie photo templates, controls the selfie-drone body to fly to the specific heights and the specific angles matching to the selfie parameters according to the sequence priorities and the selfie parameters of the selected selfie photo templates, and controls the camera unit to take photos or shoot a film in step S24. The sequence priorities are set according to a shortest-distance flight path of the selfie-drone body.

In yet another embodiment, the selecting unit selects plural selfie photo templates from the database and sets a time duration of each of the selected selfie photo templates in step S20. The controlling unit controls the selfie-drone body to fly to the specific heights and the specific angles matching to the selfie parameters of the selected selfie photo templates according to the selfie parameters of the selected selfie photo templates and the time duration of each of the selected selfie photo templates, controls the camera unit to shoot films, and combines the films corresponding to the selected selfie photo templates into a new film.

The selfie person can view effect of a selfie photo in advance via the selfie-drone system and the performing method thereof in accordance with the present invention.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A selfie-drone system, comprising:
a selfie-drone body;
a camera unit disposed in the selfie-drone body;
a selecting unit electrically coupled to a database, the database including a plurality of selfie photo templates, the selecting unit utilized for selecting at least one of the selfie photo templates from the database, each of the selfie photo templates including at least one selfie parameter, and the at least one selfie parameter comprising a position and a size of at least one pattern in the corresponding selfie photo template; and
a controlling unit electrically coupled to the camera unit and the selecting unit and utilized for receiving the at least one selfie parameter of the at least one of the selfie photo templates selected by the selecting unit, controlling the selfie-drone body based on the at least one selfie parameter to fly to a specific height and a specific angle matching to the at least one selfie parameter, and controlling the camera unit to take a photo or shoot a film.

2. The selfie-drone system according to claim 1, wherein the selfie parameter of each of the selfie photo templates comprises an orientation angle of a portrait pattern in the corresponding selfie photo template.

3. The selfie-drone system according to claim 1, wherein when the selfie photo template selected by the selecting unit is a multi-person template, the controlling unit determines the selfie person by recognizing an action of the selfie person and controls an image of the selfie person to be displayed in a specific position of a taken photo according to the selfie parameters of the multi-person template.

4. The selfie-drone system according to claim 1, wherein at least one of the selfie photo templates is created by converting a photo which is uploaded to the selfie-drone system, and the at least one created selfie photo template is stored in the database.

5. The selfie-drone system according to claim 1, wherein the selfie photo templates are stored in a mobile terminal.

6. The selfie-drone system according to claim 1, wherein the selfie photo templates are stored in the controlling unit.

7. The selfie-drone system according to claim 1, wherein the selecting unit selects plural selfie photo templates from the database, and the controlling unit controls the selfie-drone body to fly to specific heights and specific angles matching to the selfie parameters of the selected selfie photo templates according to a selection sequence of the selected selfie photo templates and the selfie parameters of the selected selfie photo templates, and controls the camera unit to take photos or shoot a film.

8. The selfie-drone system according to claim 1, wherein the selecting unit selects plural selfie photo templates from the database, and the controlling unit sets sequence priorities of the selected selfie photo templates, controls the selfie-drone body to fly to specific heights and specific angles matching to the selfie parameters of the selected selfie photo templates according to the sequence priorities and the selfie parameters of the selected selfie photo templates, and controls the camera unit to take photos or shoot a film, and the sequence priorities are set according to a shortest-distance flight path of the selfie-drone body.

9. The selfie-drone system according to claim 1, wherein the selecting unit selects plural selfie photo templates from the database and sets a time duration of each of the selected selfie photo templates, and the controlling unit controls the selfie-drone body to fly to specific heights and specific angles matching to the selfie parameters of the selected selfie photo templates according to the selfie parameters of the selected selfie photo templates and the time duration of each of the selected selfie photo templates, controls the camera unit to shoot films, and combines the films corresponding to the selected selfie photo templates into a new film.

10. A performing method of a selfie-drone system, the selfie-drone system comprising a selfie-drone body, a camera unit, a selecting unit, and a controlling unit, the performing method of the selfie-drone system comprising:
selecting at least one of a plurality of selfie photo templates from a database by the selecting unit, each of the selfie photo templates including at least one selfie parameter, and the at least one selfie parameter comprising a position and a size of at least one pattern in the corresponding selfie photo template;
receiving the at least one selfie parameter of the at least one of the selfie photo templates by the controlling unit; and
controlling the selfie-drone body based on the at least one selfie parameter to fly to a specific height and a specific angle matching to the at least one selfie parameter by the controlling unit, and controlling the camera unit to take a photo or shoot a film.

11. The performing method of the selfie-drone system according to claim 10, wherein the selfie parameter of each of the selfie photo templates comprises an orientation angle of a portrait pattern in the corresponding selfie photo template.

12. The performing method of the selfie-drone system according to claim 10, wherein when the selfie photo template selected by the selecting unit is a multi-person template, the controlling unit determines the selfie person by recognizing an action of the selfie person and controls an image of the selfie person to be displayed in a specific position of a taken photo according to the selfie parameters of the multi-person template.

13. The performing method of the selfie-drone system according to claim 10, wherein at least one of the selfie photo templates is created by converting a photo which is uploaded to the selfie-drone system, and the at least one created selfie photo template is stored in the database.

14. The performing method of the selfie-drone system according to claim 10, wherein the selecting unit selects plural selfie photo templates from the database, and the controlling unit controls the selfie-drone body to fly to specific heights and specific angles matching to the selfie parameters of the selected selfie photo templates according to a selection sequence of the selected selfie photo templates and the selfie parameters of the selected selfie photo templates, and controls the camera unit to take photos or shoot a film.

15. The performing method of the selfie-drone system according to claim 10, wherein the selecting unit selects plural selfie photo templates from the database, and the controlling unit sets sequence priorities of the selected selfie photo templates, controls the selfie-drone body to fly to specific heights and specific angles matching to the selfie parameters of the selected selfie photo templates according to the sequence priorities and the selfie parameters of the selected selfie photo templates, and controls the camera unit to take photos or shoot a film, and the sequence priorities are set according to a shortest-distance flight path of the selfie-drone body.

16. The performing method of the selfie-drone system according to claim 10, wherein the selecting unit selects plural selfie photo templates from the database and sets a time duration of each of the selected selfie photo templates, and the controlling unit controls the selfie-drone body to fly to specific heights and specific angles matching to the selfie parameters of the selected selfie photo templates according to the selfie parameters of the selected selfie photo templates and the time duration of each of the selected selfie photo templates, controls the camera unit to shoot films, and combines the films corresponding to the selected selfie photo templates into a new film.
